(19) United States
(12) Patent Application Publication
(10) Pub. No.: US 2017/0321169 A1
(43) Pub. Date: Nov. 9, 2017

(54) CLEANING COMPOSITIONS

(71) Applicant: The Procter & Gamble Company, Cincinnati, OH (US)

(72) Inventors: Ming TANG, Beijing (CN); Qing CHEN, Beijing (CN); Hong Sing TAN, Beijing (CN); Daitao GENG, Beijing (CN); Alan Thomas BROOKER, Newcastle upon Tyne (GB)

(21) Appl. No.: 15/585,190

(22) Filed: May 3, 2017

(30) Foreign Application Priority Data
May 5, 2016 (CN) PCT/CN2016/081084

(51) Int. Cl. C11D 11/00; C11D 10/04; C11D 3/386; C11D 3/12; C11D 17/06; C11D 3/37; C11D 1/14; C11D 1/29; C11D 1/22

(52) U.S. Cl. CPC C11D 11/0017; C11D 17/06; C11D 10/042; C11D 3/38609; C11D 3/3788; C11D 3/128; C11D 1/29; C11D 1/22; C11D 1/146

(57) ABSTRACT

A cleaning composition, preferably a granular laundry detergent composition, contains 1.5 wt % to 10 wt % of soap particles characterized by a particle size distribution with from 35 wt % to 100 wt % of soap particles having particle sizes ranging from about 125 microns to about 355 microns. Soap particles with such a particle size distribution are surprisingly more effective in boosting suds volume of the cleaning composition during a fabric washing cycle.

### FIELD OF THE INVENTION

The present invention concerns cleaning compositions, preferably granular detergent compositions, with improved sudsing profile, which contain soap particles of specific particle sizes with one or more non-soap surfactants.

### BACKGROUND OF THE INVENTION

Fatty acids or salts thereof (hereinafter “soaps”) are commonly used in cleaning composition, especially in powder or granular detergent compositions, for various purposes, including as detersive surfactants, carriers, aesthetic particles, or foam suppressors.

EP265258 employs colored soap noodles in detergent powders as carriers for special additives such as catalysts, enzymes, fluorescers or photobleaches, or as aesthetic particles to highlight the particular attributes of the detergent powders. The soap noodles employed for such purposes are about 0.3-2 mm or preferably 0.5-1 mm in diameter, and about 3-20 mm or preferably 5-10 mm in length. They are mixed with spray-dried detergent base powder to form a finished product composed of white granules interspersed with distinctive color noodles.

EP432449 combines soap scales or granules with anionic surfactants such as linear alkylbenzene sulphonates (LAS) and alkyl sulphates (AS) and nonionic surfactants such as polyethoxylated or polypropoxylated alcohols to form powdered detergents with a good foam-control capacity during washing and rinsing, which are particularly suitable for use in washing machines. The soap granules may have dimensions of 0.2-3 mm The soap scales, which are more preferred, may have dimensions of 1-10 mm or preferably 2-5 mm. They can be added by dry-mixing into the base detergent powder after such powder is formed by atomization.

U.S. Pat. No. 5,443,751 uses very small particulate soaps to form an adherent coating over the surface of detergent granules that contain anionic surfactant, nonionic surfactant, inorganic salt builder, and alkali metal silicate, so as to reduce undissolved residue from such detergent granules under cold water washing conditions. The particulate soaps used for this purpose have an average particle size between about 50-200 microns, preferably from 70-180 microns, and more preferably from 90-110 microns (see Example I).

EP1633846 discloses the use of larger soap granules (in comparison with those used in U.S. Pat. No. 5,443,751) in combination with anionic surfactants and nonionic granules to form granular laundry detergent compositions with improved dissolution across a wide range of water hardnesses. Such soap granules have a particle size of from 400 to 1400 microns, and preferably from 500 to 1200 microns.

However, none of these references teaches or suggests the use of soap particles having particle sizes within a relatively narrow range, e.g., from about 125 microns to about 355 microns and preferably from about 125 microns to about 250 microns, let alone recognizing or appreciating any unique benefit that can be achieved by selecting soap particles having particle sizes within such range.

It has now been surprisingly found that soap particles having particle sizes within the range of 125-355 microns when used at a sufficiently high amount are not only effective in reducing foam or suds during the rinse cycle of a cleaning process, but are also capable of maintaining or boosting the foam or suds during the wash cycle of such cleaning process, in comparison with soap particles having particle sizes falling outside of the above-mentioned range. Cleaning compositions containing soap particles of the present invention are characterized by an improved suds profile that are particularly useful for handwashing fabrics or other items.

### SUMMARY OF THE INVENTION

The present invention relates to a cleaning composition that contains: (a) from about 5% to about 50% of one or more non-soap surfactants; and (b) from about 1.5% to about 10% of soap particles by total weight of the cleaning composition, while the soap particles are characterized by a particle size distribution with from 35 wt % to 100 wt % of soap particles having particle sizes ranging from about 125 microns to about 355 microns.

The present invention also relates to use of the above-described cleaning composition for hand-washing fabrics or other items.

Further, the present invention relates to use of soap particles for boosting wash suds and suppressing rinse suds of a cleaning composition, while the soap particles are present in the cleaning composition in an amount ranging from 1.5% to 10% by total weight of the cleaning composition, and while such soap particles are characterized by a particle size distribution with from 35 wt % to 100 wt % of soap particles having particle sizes ranging from about 125 microns to about 355 microns.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “cleaning composition” includes, unless otherwise indicated, granular or powder-form all-purpose or “heavy-duty” washing agents, especially cleaning detergents, for fabrics, as well as cleaning auxiliaries such as bleach, rinse aids, additives, or pre-treat types; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a solid or granular detergent composition, and more preferably a free-flowing particulate laundry detergent composition (i.e., a granular laundry detergent product).

As used herein, the terms “consisting essentially of” means that the composition contains less than about 1%, preferably less than about about 0.5%, of ingredients other than those listed.

Further, the terms “essentially free of,” “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels.

The term “particle size” as used herein is determined by the ability of a particle to pass through sieves of specific dimensions using ASTM D 502 - 89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #40 (with a mesh size of about 425 μm), #45 (with a mesh size of about 355 μm), #60 (with a mesh size of about 250 μm), and #120 (with a mesh size of about 125 μm) is required. The prescribed Machine-Sieving Method is used to separate soap particles based on their particle sizes, by employing a suitable sieve-shaking machine from W.S. Tyler Company of Mentor, Ohio, U.S.A. For example, soap particles that cannot pass through the sieve #40 (with a mesh size of about 425 μm) are deemed to have particle sizes greater than 425 microns, and soap particles that can pass through the sieve #120 (with a mesh size of about 125 μm) are deemed to have particle sizes equal to or smaller than 125 microns. For another example, soap particles that can pass through the sieve #45 (with a mesh size of about 355 μm) but cannot pass through the sieve #60 (with a mesh size of about 250 μm) are deemed to have particle size greater than 250 microns but equal to or smaller than 355 microns. For yet another example, soap partiles that can pass through the sieve the sieve #60 (with a mesh size of about 250 μm) but cannot pass through the sieve #120 (with a mesh size of about 125 μm) are deemed to have particle size greater than 125 microns but equal to or smaller than 250 microns.

As used herein, the term “water-soluble” refers to a solubility of more than about 30 grams per liter (g/L) of deionized water measured at 20° C. and under the atmospheric pressure.

As used herein, “suds” indicates a non-equilibrium dispersion of gas bubbles in a relatively smaller volume of a liquid. The terms like “suds”, “foam” and “lather” can be used interchangeably within the meaning of the present invention.

As used herein, “suds profile” or “sudsing profile” refers to the properties of a cleaning composition relating to suds character during the wash and rinse cycles. The suds profile of a cleaning composition includes, but is not limited to, the speed of suds generation upon dissolution in the laundering liquor, the volume and retention of suds in the wash cycle, and the volume and disappearance of suds in the rinse cycle. Preferably, the suds profile includes the wash suds volume and rinse suds volume. It may further include additional suds-related parameters, such as suds stability measured during the washing cycle and the like.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

Although automatic washing machine, either for garments or for dishes, has been widely accepted and used in modern day homes, there are still many situations where people need to resort to hand-washing, for example, when special care is needed for delicate gartments or when tough stains are involved. Indeed, in most developing countries, consumers' washing habit for laundry is still to wash their garments or dishes by hand in basins or buckets, which involves the steps of washing with detergent and rinsing one or more times with water.

Sudsing profile of a cleaning composition, which includes but is not limited to: the speed and volume of suds generated upon dissolving the detergent composition in a washing solution, look and feel of the suds so generated, retention of suds during the washing cycle, and easiness in rinsing the suds off during the rinse cycle, is particularly important for consumers who still hand wash their garments or dishes, because their laundering experience is directly impacted thereby. On one hand, consumers typically view copious suds during the wash cycle as the primary and most desirable signal of cleaning, i.e., an indication that the detergent is “working” and that sufficient cleaning has been achieved. Therefore, high suds volumes during the wash cycle is especially desirable. On the other hand, when the consumers observe residue suds during the rinse cycle, they immediately infer from it that there may still be surfactant residue on the garments or dishes and that they are not yet “clean.” Consequently, the consumers feel the need to rinse the garments or dishes multiple times in order to make sure that the surfactants are removed thoroughly, which requires additional time, energy and water. For regions where resource is scarce, especially those regions suffering from water shortage, such excessive rinse requirement may render the detergent difficult or expensive to use.

Hence, while high volume of suds is desirable during the wash cycle, fast and significant reduction of suds volume during the rinse cycle is also desirable for a cleaning composition used for handwashing fabrics or other items (e.g., dishes).

Soaps are known for reducing total suds volume and have been used by conventional art to reduce suds generation and control foam. However, such suds-reduction or foam-control effect of soaps is present during both the wash cycle and the rinse cycle, resulting in an overall low suds profile throughout the cleaning process that is suitable for machine washing purposes but not for handwashing purposes.

It has been a surprising discovery that soap particles with particle sizes ranging from about 125 to about 355 microns (preferably from about 125 microns to about 250 microns) can be used to improve the suds profile of a cleaning composition in order to meet the above-described handwashing needs. When present at a sufficiently high amount either as a pure form (e.g., from about 1.5 wt % to about 10 wt %, preferably from about 1.5 wt % to about 6 wt %, and more preferably from about 1.5 wt % to about 5 wt % by weight of the cleaning composition) or as a mixture of soap particles of different sizes (e.g., accounting for from about 35 wt % to 100 wt %, preferably from about 40 wt % to 100 wt %, more preferably from about 70 wt % to 100 wt %, and most preferably from about 90 wt % to 100 wt % of such mixture) and in combination with one or more non-soap surfactants (especially anionic surfactants such as LAS and AS), such soap particles are not only effective in reducing or suppressing suds during the rinse cycle of a cleaning process, but are also effective in boosting or maintaining suds during the wash cycle.

The resulting cleaning composition containing such soap particles and non-soap surfactants is therefore ideal for handwashing fabrics or other items.

### Soap Particles

Soap particles employed by the present invention are characterized by a particle size that is ranging from about 125 to about 355 microns, or preferably ranging from about 125 to about 250 microns. It has been a suprising and unexpected discovery of the present invention that soap particles with particle sizes within the above-described ranges are not only effective in significantly reducing foam or suds during the rinse cycle of a cleaning process, but are also capable of boosting the foam or suds during the wash cycle of such cleaning process. In contrast, soap particles with particle sizes falling outside of the above-mentioned ranges (e.g., either smaller than 125 microns or greater than 355 microns) lead to suds reduction both during the rinse and wash cycles.

Soap particles of the present invention contain one or more C₁₀-C₂₂ fatty acids or alkali salts thereof. Such alkali salts include monovalent or divalent alkali metal salts like sodium, potassium, lithium and/or magnesium salts as well as the ammonium and/or alkylammonium salts of fatty acids, preferably the sodium salt. Preferred fatty acids or salts thereof for use herein contain from 10 to 20 carbon atoms, and more preferably 12 to 18 carbon atoms. In a particularly preferred embodiment of the present invention, the soap particles used in the cleaning composition are formed substantially of, or more preferably essentially of, fatty acids or salts having from about 10 to about 20 carbon atoms, more preferably from about 12 to about 18 carbon atoms.

Exemplary fatty acids that can be used may be selected from caprylic acid, capric acid, lauric acid, myristic acid, myristoleic acid, palmitic acid, palmitoleic acid, sapienic acid, stearic acid, oleic acid, elaidic acid, vaccenic acid, linoleic acid, linoelaidic acid, a-linoelaidic acid, arachidic acid, arachidonic acid, eicosapentaenoic acid, behenic acid, erucic acid, and docosahexaenoic acid, and mixtures thereof.

Saturated fatty acids, such as caprylic acid, capric acid, lauric acid, myristic acid, palmitic acid, stearic acid, arachidic acid, behenic acid, and mixtures thereof, are preferred, but not necessary, for the practice of the present invention. Among these saturated fatty acids, lauric acid, myristic acid and palmitic acid are particularly preferred.

The above-described soap particles, i.e., soap particles with particle sizes in the above-specified range of 125-355 microns (“Inventive Soap Particles”) or preferably 125-250 microns (“Preferred Inventive Soap Particles”) can be used either in a pure form or in a mixture of soap particles of different sizes.

The cleaning composition of the present invention preferably contains the Inventive Soap Particles or Preferred Inventive Soap Particles in the pure form, i.e., it is substantially free of or essentially free of soap particles of other particle sizes. For example, the cleaning composition may contain only the Inventive Soap Particles at the required level of from about 1.5 wt % to about 10 wt %, preferably from about 1.5 wt % to about 6 wt %, and more preferably from about 1.5 wt % to about 5 wt %. For another and more preferred example, the cleaning composition contains only the Preferred Inventive Soap Particles at the required level of from about 1.5 wt % to about 10 wt %, preferably from about 1.5 wt % to about 6 wt %, and more preferably from about 1.5 wt % to about 5 wt %.

Alternatively, the cleaning composition of the present invention may contain a mixture of soap particles of different particle sizes, including both Inventive Soap Particles and non-inventive soap particles (i.e., those with particle sizes falling outside of such ranges), as long as such mixture is enriched with the Inventive Soap Particles or the Preferred Inventive Soap Particles. The term “enriched” means that the mixture is chararcterized by a particle size distribution with from about 35 wt % to 100 wt %, preferably from about 40 wt % to 100 wt %, more preferably from about 70 wt % to 100 wt %, and most preferably from about 90 wt % to 100 wt %, of the Inventive Soap Particles or the Preferred Inventive Soap Particles. For example, the cleaning composition may contain ground soap particles which are made by grinding the Palmosalt NP021 soap powder sourced from Taiko Palm Oleo Zhangjiagang Co., Ltd, using a pin mill under N₂ gas or dry ice for cooling down the soap praticles during the grinding process. Such ground soap particles are a mixture containing about 20 wt % soap particles with particle sizes smaller than 125 microns, about 25 wt % soap particles with particle sizes from about 125 microns to about 250 microns, about 23 wt % soap particles with particle sizes from about 250 microns to about 355 microns, about 6 wt % soap particles with particle sizes from about 355 microns to about 425 microns, and about 26 wt % soap particles with particle sizes greater than about 425 microns. Soap mixtures with the above-described particle size distribution help to boost or increase the wash suds volume and improve the overall sudsing performance of the cleaning composition. When such a mixture is used, it is preferred that it is present in the cleaning composition from about 1.5 wt % to about 10 wt %, preferably from about 2 wt % to about 6 wt %, and more preferably from about 2.5 wt % to about 5 wt %.

### Non-Soap Surfactants

The cleaning composition may contain non-soap surfactants in the amount ranging from about 5% to about 50% by total weight of the composition. Preferably, the cleaning composition contains from about 10% to about 40%, and more preferably from about 15% to about 30%, of non-soap surfactants by total weight of such composition.

The non-soap surfactants may be selected from the group consisting of anionic surfactants, non-ionic surfactants, zwitterionic surfactants, and/or cationic surfactants. Preferably, anionic surfactants are present as the main surfactant in the non-soap surfactant system, i.e., more than 50% by weight of the non-soap surfactants in the cleaning composition of the present invention are anionic surfactants. More preferably, from about 80% to about 100% by weight of the non-soap surfactants in the cleaning composition of the present invention are anionic surfactants. Still more preferably, the anionic surfactants include: (i) a C₁₀-C₂₀ linear alkylbenzene sulphonate (LAS); and (ii) an alkyl sulphate (AS) having a branched or linear unalkoxylated alkyl group containing from about 6 to about 18 carbon atoms. The LAS and AS can be present in such cleaning composition at a LAS-to-AS weight ratio of from about 3:1 to about 24:1, preferably from about 3.5:1 to about 20:1, more preferably from about 4:1 to about 15:1, and most preferably from about 5:1 to about 10:1.

One aspect of the present invention relates to a cleaning composition containing: (a) from about 6 wt % to about 15 wt % of LAS; and (b) from about 0.3 wt % to about 4.0 wt % of AS. Preferably, but not necessarily, the cleaning composition contains from 0 wt % to about 1 wt % of a linear or branched alkylalkoxy sulphate (AXS) having a weight average degree of alkoxylation ranging from about 0.1 to about 10.

### LAS

The cleaning composition of the present invention may include a C₁₀-C₂₀ linear alkylbenzene sulphonate (LAS). LAS anionic surfactants are well known in the art and can be readily obtained by sulphonating commercially available linear alkylbenzenes. Exemplary C₁₀-C₂₀ linear alkylbenzene sulphonates that can be used in the present invention include alkali metal, alkaline earth metal or ammonium salts of C₁₀-C₂₀ linear alkylbenzene sulphonic acids, and preferably the sodium, potassium, magnesium and/or ammonium salts of C₁₁-C₁₈ or C₁₁-C₁₄ linear alkylbenzene sulphonic acids. More preferred are the sodium or potassium salts of C₁₂ linear alkylbenzene sulphonic acids, and most preferred is the sodium salt of C₁₂ linear alkylbenzene sulphonic acid, i.e., sodium dodecylbenzene sulphonate.

The amount of LAS used in the cleaning composition may range from about 6% to about 15%, preferably from about 7% to about 13%, and more preferably from about 9% to about 12%, by total weight of the composition. In a most preferred embodiment of the present invention, the cleaning composition contains from about 9 wt % to about 12 wt % of a sodium, potassium, or magnesium salt of C₁₂ linear alkylbenzene sulphonic acid.

When the cleaning the cleaninig composition is in a concentrated form, especially a concentrated powder or granular form, the LAS can be present at a significantly higher level, e.g., from about 12% to about 30%, preferably from about 15% to about 25%, and more preferably from about 18% to about 24%, by total weight of the concentrated cleaning composition.

AS

The cleaning composition of the present invention may further include, as a co-surfactant for LAS, an anionic alkyl sulphate (AS) surfactant having a branched or linear unalkoxylated alkyl group containing from about 6 to about 18 carbon atoms. Preferably, the AS has the generic formula of R—O—SO₃⁻M⁺, while R is branched or linear unalkoxylated C₆-C₁₈ alkyl group, and M is a cation of alkali metal, alkaline earth metal or ammonium. More preferably, the R group of the AS surfactant contains from about 6 to about 16 carbon atoms, and more preferably from about 6 to about 14 carbon atoms. R can be substituted or unsubstituted, and is preferably unsubstituted. R is substantially free of any alkoxylation. M is preferably a cationic of sodium, potassium, or magnesium, and more preferably M is a sodium cation. Such AS surfactant acts as a co-surfactant for the LAS to boost suds volume during the wash. Preferably, but not necessarily, the cleaning composition of the present invention contains a mixture of C₆-C₁₈ AS surfactants, in which C₆-C₁₄ AS surfactants are present in an amount ranging from about 85% to about 100% by total weight of the mixture. This mixture can be referred to as a “C₆-C₁₄-rich AS mixture.” More preferably, such C₆-C₁₄-rich AS mixture contains from about 90 wt % to about 100 wt %, or from 92 wt % to about 98 wt %, or from about 94 wt % to about 96 wt %, or 100 wt % (i.e., pure), of C₆-C₁₄ AS.

In a particularly preferred embodiment of the present invention, the cleaning composition contains a mixture of C₆-C₁₈ AS surfactants with from about 30 wt % to about 100 wt % or from about 50 wt % to about 99 wt %, preferably from about 60 wt % to about 95 wt %, more preferably from about 65 wt % to about 90 wt %, and most preferably from about 70 wt % to about 80 wt % of C₁₂ AS. Further, such mixture of C₆-C₁₈ AS surfactants may contain from about 10 wt % to about 100 wt %, preferably from 15 wt % to about 50 wt %, and more preferably from 20 wt % to about 30 wt % of C₁₄ AS. This mixture can be referred to as a “C₁₂-C₁₄-rich AS mixture.”

In a most preferred embodiment of the present invention, the cleaning composition contains a mixture of AS surfactants that consists essentially of C₁₂ and/or C₁₄ AS surfactants.

For example, such mixture of AS surfactant may consist essentially of from about 70 wt % to about 80 wt % of C₁₂ AS and from 20 wt % to about 30 wt % of C₁₄ AS, with little or no other AS surfactants therein. Such mixture may also consist of substantially pure C₁₂ AS, or alternatively, substantially pure C₁₄ AS.

A commercially available AS mixture particularly suitable for practice of the present invention is Texapon® V95 G from Cognis (Monheim, Germany)

Further, the cleaning composition of the present invention may contain a mixture of C₆-C₁₈ AS surfactants comprising more than about 50 wt %, preferably more than about 60 wt %, more preferfably more than 70 wt % or 80 wt %, and most preferably more than 90 wt % or even at 100 wt % (i.e., substantially pure), of linear AS surfactants having an even number of carbon atoms, including, for example, C₆, C₈, C₁₀, C₁₂, C₁₄, C₁₆, and C₁₈ AS surfactants.

The mixture of C₆-C₁₈ AS surfactants as described can be readily obtained by sulphonation of alcohol(s) with the corresponding numbers of carbon atoms. The required carbon chain length distribution can be obtained by using alcohols with the corresponding chain length distribution parepared either synthetically or extracted/purified from natural raw materials or formed by mixing corresponding pure starting materials. For example, the mixture of C₆-C₁₈ AS surfactants may be derived from naturally occurring triglycerides, such as those contained in palm kernel oil or coconut oil, by chemically processing such triglycerides to form a mixture of long chain alcohols and then sulphonating such alcohols to form AS surfactants. The mixture of alcohols derived from the naturally occurring triglycerides typically contain more than about 20 wt % of C₁₆-C₁₈ alcohols. A mixture containing a lower proportion of C₁₆-C₁₈ alcohols may be separated from the original mixture before the sulphonation step, in order to form the desired mixture of C₆-C₁₈ AS surfactants as described hereinabove. Alternatively, the desired mixture of C₆-C₁₈ AS surfactants can be readily obtained by separating and purifying the already formed AS mixtures. Suitable separation and purification methods include, but are not limited to: distillation, centrifugation, recrystallization and chromatographic separation.

The amount of AS surfactants used in the cleaning composition of the present invention may range from about 0.3 wt % to about 4.0 wt %, and preferably from about 0.5 wt % to about 3 wt % by total weight of the composition. In a most preferred embodiment of the present invention, the cleaning composition contains from about 0.5 wt % to about 3 wt % of an AS mixture consistenting essentially of from about 70 wt % to about 80 wt % of C₁₂ AS and from 20 wt % to about 30 wt % of C₁₄ AS.

When the cleaning the cleaninig composition is in a concentrated form, especially a concentrated powder or granular form, the AS can be present at a significantly higher level, e.g., from about 0.5% to about 8%, preferably from about 1% to about 5%, and more preferably from about 2% to about 4%, by total weight of the concentrated cleaning composition.

### LAS:AS Ratio

As a co-surfactant for LAS, the AS is the most effective if it is provided in the cleaning composition at an amount to render a weight ratio of LAS to AS within the range of from about 3:1 to about 24:1, preferably from about 3.5:1 to about 20:1, more preferably from about 4:1 to about 15:1, and most preferably from about 5:1 to about 10:1. The LAS-to-AS ratio does not vary when the cleaning composition changes from a standard form to a concentrated form. The cleaning composition of the present invention with such a LAS-to-AS weight ratio exhibits a right balance between the amounts of wash and rinse suds generated. It also helps to maintain good sudsing profile across different regions with diverse dosing habit.

### Alkoxylated Alkyl Sulphate (AXS)

The cleaning composition of the present invention employs AS instead of alkylalkoxy sulphate (AXS) as a co-surfactant for LAS. In comparison with AXS, the AS co-surfactant has a significant better rinse suds profile (i.e., reduced rinse suds volume) and is therefore particularly useful for imparting the easy rinse benefit to the cleaning composition so formed. Consequently, the cleaning composition of the present invention is substantially free of AXS, especially alkylethoxy sulphate (AES). In other words, the cleaning composition of the present invention contains AXS, or more specifically AES, in an amount ranging from 0 wt % to about 1 wt %, preferably from 0 wt % to about 0.8 wt %, or more preferably from 0 wt % to about 0.5 wt %, and most preferably at a level that is not analytically detectable. AXS as used herein refers to any linear or branched AXS having a weight average degree of alkoxylation ranging from about 0.1 to about 10.

When the cleaning the cleaninig composition is in a concentrated form, especially a concentrated powder or granular form, the AXS is preferably present in an amount ranging from 0% to about 2%, preferably from about 0% to about 1.5%, and more preferably from about 0% to about 1%, by total weight of the concentrated cleaning composition.

### Other Non-Soap Surfactants

In addition to the non-soap surfactants described hereinabove, the cleaning composition of the present invention may comprise one or more other non-soap surfactant(s) selected from other anionic surfactants (other than LAS, AS, and AXS described hereinabove), nonionic surfactants, cationic surfactants, ampholytic surfactants, zwitterionic surfactants, semi-polar nonionic surfactants and mixtures thereof.

The cleaning compositions of the invention may comprise additional anionic surfactants which comprise one or more moieties selected from the group consisting of carbonate, phosphate, phosphonate, sulphate, sulfonate, carboxylate and mixtures thereof and which do not fall within the above descriptions for the LAS, AS, and AES surfactants.

In certain aspects, the cleaning composition comprises from about 0.01% to about 2%, by weight of the composition, of one or more nonionic surfactants. In certain aspects, the cleaning composition has a nonionic surfactant level that does not exceed about 1%, e.g., from about 0.1% to about 1% or about 0.5% to about 0.8%, by weight of the composition.

Suitable nonionic surfactants useful herein can comprise any conventional nonionic surfactant. In some aspects, the nonionic surfactant is selected from alkyl alkoxylated alcohols, such as a C₈₋₁₈ alkyl alkoxylated alcohol having an average degree of alkoxylation of from about 1 to about 50, or from about 1 to about 40, or from about 1 to about 30, or from about 1 to about 20. The alkyl alkoxylated alcohol can be linear or branched, substituted or unsubstituted.

In some examples, the cleaning compositions may contain an ethoxylated nonionic surfactant. The nonionic surfactant may be selected from the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 1 to about 50, preferably from about 1 to about 40, and more preferably from about 1 to about 30. In one example, the nonionic surfactant is selected from ethoxylated alcohols having an average of from about 12 to about 14 or from about 12 to about 15 carbon atoms in the alcohol and an average degree of ethoxylation of about 7-9 moles of ethylene oxide per mole of alcohol.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic from BASF; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkyl alkoxylated alcohol. Suitable nonionic surfactants also include those sold under the tradename Lutensol® from BASF.

The cleaning compositions of the present invention may comprise a cationic surfactant. When present, the composition typically comprises from about 0.05 wt % to about 5 wt %, or from about 0.1 wt % to about 2 wt % of such cationic surfactant. Suitable cationic surfactants are alkyl pyridinium compounds, alkyl quaternary ammonium compounds, alkyl quaternary phosphonium compounds, and alkyl ternary sulfonium compounds. The cationic surfactant can be selected from the group consisting of: alkoxylate quaternary ammonium (AQA) surfactants; dimethyl hydroxyethyl quaternary ammonium surfactants; polyamine cationic surfactants; cationic ester surfactants; amino surfactants, specifically amido propyldimethyl amine; and mixtures thereof. Highly preferred cationic surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

### Alkoxylated Polyalkyleneimine Suds Collapser

In a preferred but not necessary embodiment of the present invention, the cleaning composition includes a suds collapser that is an alkoxylated polyalkyleneimine, which causes the suds to collapse at a predetermined time, typically during the rinse cycle, instead of throughout the entire washing and rinsing duration. Preferably, the suds collapsing is triggered by an event or a condition, for example, a pH change, to cause the suds in the laundry liquor to collapse, burst and/or otherwise remove them from perception at a faster rate than if the suds collapser is not present, or is not activated.

Specifically, the alkoxylated polyalkyleneimine may contain a polyalkyleneimine backbone or core that is modified by replacing one or more hydrogen atoms attached to the nitrogen atoms in such backbone or core with polyoxyalkyleneoxy unit, i.e., —(CₙH₂ₙO)ₓH, while n is an integer ranging from about 1 to about 10, preferably from about 1 to about 5, and more preferably from about 2 to about 4, and x is an integer ranging from 1 to 200, preferably from about 2 to about 100, and more preferably from about 5 to about 50. The polyalkyleneimine backbone or core typically has an average number-average molecular weight (Mwₙ) prior to modification within the range of from about 100 to about 100,000, preferably from about 200 to about 5000, and more preferably from about 500 to about 1000.

More preferably, the alkoxylated polyalkyleneimine suds collapser of the present invention has a polyethyleneimine core with inner polyethylene oxide blocks and outer polypropylene oxide blocks. Specifically, such alkoxylated polyalkyleneimine has an empirical formula of (PEI)ₐ(CH₂CH₂O)_{b}(CH₂CH₂CH₂O)_{c}, while PEI stands for a polyethyleneimine core, while a is the average number-average molecular weight (Mwₙ) prior to modification within the range of from about 100 to about 100,000 Daltons; b is the weight average number of ethylene oxide (CH₂CH₂O) units per nitrogen atom in the PEI core, which is an integer ranging from about 0 to about 60; and c is the weight average number of propylene oxide (CH₂CH₂CH₂O) units per nitrogen atom in the PEI core, which is an integer ranging from about 0 to about 60. Preferably, a ranges from about 200 to about 5000 Daltons, and more preferably from about 500 to about 1000 Daltons; preferably b ranges from about 10 to about 50, and more preferably from about 15 to about 40, and most preferably from about 20 to about 30; and preferably c ranges from about 0 to about 60, preferably from about 1 to about 50, and more preferably from about 5 to about 40, and most preferably from about 10 to about 30. Please note that the empirical formula shows only the relative amounts of each of the constituents, and is not intended to indicate the structural order of the different moieties.

The suds collapser is typically present in the cleaning composition at an amount ranging from about 0.05 wt % to about 5 wt %, preferably from about 0.2 wt % to about 3 wt %, more preferably from about 0.3 wt % to about 2 wt %, and most preferably from about 0.35 wt % to about 1 wt % by total weight of the composition. Without intending to be limited by theory, it is believed that the suds collapser herein may reduce initial suds in the rinse by at least about 25%, or from about 25% to about 100%, or from about 50% to about 100%, or from about 60% to about 100%, as compared to when no suds collapser is present.

### Amphiphilic Graft Copolymer(s)

The amphiphilic graft copolymers employed by the present invention are characterized by a polyalkylene oxide (also referred to as poyalkylene glycol) backbone grafted with one or more side chains.

The polyalkylene oxide backbone of the amphiphilic graft copolymers of the present invention may comprise repeated units of C₂-C₁₀, preferably C₂-C₆, and more preferably C₂-C₄, alkylene oxides. For example, the polyalkylene oxide backbone may be a polyethylene oxide (PEO) backbone, a polypropylene oxide (PPO) backbone, a polybutylene oxide (PBO) backbone, or a polymeric backbone that is a linear block copolymer of PEO, PPO, and/or PBO, while the PEO backbone is preferred. Such a polyalkylene oxide backbone preferably has a number average molecular weight of from about 2,000 to about 100,000 Daltons, more preferably from about 4,000 to about 50,000 Daltons, and most preferably from about 5,000 to about 10,000 Daltons.

The one or more side chains of the amphiphilic graft copolymers of the present invention are formed by polymerizations of vinyl esters of C₂-C₁₀, preferably C₂-C₆, and more preferably C₂-C₄, carboxylic acids. For example, the one or more side chains may be selected from the group consisting of polyvinyl acetate, polyvinyl propionate, polyvinyl butyrate, and combinations thereof, while polyvinyl acetate is preferred. The polyvinyl ester side chains may be partially saponified, for example, to an extent of up to 15%. The amphiphilic graft copolymer is preferably characterized by an average of no more than 1 graft site (i.e., the site on the polymeric backbone where a polyvinyl ester side chain is grafted thereto) per 50 alkyleneoxide units on the backbone.

The amphiphilic graft copolymers of the present invention may have an overall mean molar masses (M_{w}) of from about 3000 to about 100,000 Daltons, preferably from about 10,000 to about 50,000 Daltons, and more preferably from about 20,000 to about 40,000 Daltons.

Particularly preferred amphiphilic graft copolymers of the present invention have a polyethylene oxide backbone grafted with one or more side chains of polyvinyl acetate. More preferably, the weight ratio of the polyethylene oxide backbone over the polyvinyl acetate side chains ranges from about 1:0.2 to about 1:10, or from about 1:0.5 to about 1:6, and most preferably from about 1:1 to about 1:5. One example of such preferred amphiphilic graft copolymers is the Sokalan^{Tm} HP22 polymer, which is commercially available from BASF Corporation. This polymer has a polyethylene oxide backbone grafted with polyvinyl acetate side chains. The polyethylene oxide backbone of this polymer has a number average molecular weight of about 6,000 Daltons (equivalent to about 136 ethylene oxide units), and the weight ratio of the polyethylene oxide backbone over the polyvinyl acetate side chains is about 1:3. The number average molecular weight of this polymer itself is about 24,000 Daltons.

Preferably, but not necessarily, the amphiphilic graft copolymers of the present invention have the following properties: (i) the surface tension of a 39 ppm by weight polymer solution in distilled water is from about 40 mN/m to about 65 mN/m as measured at 25° C. by a tensiometer; and (ii) the viscosity of a 500 ppm by weight polymer solution in distilled water is from about 0.0009 to about 0.003 Pa·S as measured at 25° C. by a rheometer. The surface tension of the polymer solution can be measured by any known tensiometer under the specified conditions. Non-limiting tensiometers useful herein include Kruss K12 tensiomerter available from Kruss, Thermo DSCA322 tensiometer from Thermo Cahn, or Sigma 700 tensiometer from KSV Instrument Ltd. Similarly, the viscosity of the polymer solution can be measured by any known rheometer under the specified conditions. The most commonly used rheometer is a rheometer with rotational method, which is also called a stress/strain rheometer. Von limiting rheometers useful herein include Hakke Mars rheometer from Thermo. Phvsica 2000 rheometer from Anton Paar.

Selected embodiments of the amphiphilic graft copolymers for use in the present invention as well as methods of making them are described in detail in PCT Patent Application No. WO 2007/138054, US Patent Application No. 2011/0152161, US Patent Application No. 2009/0023625, U.S. Pat. No. 8,143,209, and US Patent Application No. 2013/025874.

The amphiphilic graft copolymer(s) may be present in the cleaning composition of the present invention in an amount ranging from about 0.3 wt % to about 3 wt % or from about 0.35 wt % to about 2 wt % by total weight of the composition. They are found to provide excellent hydrophobic soil suspension even in the presence of cationic coacervating polymers.

### Silicone-Containing Particles

In a preferred but not necessary embodiment of the present invention, the cleaning composition is a granular or powdery laundry detergent composition containing from about 0 wt % to about 1 wt % of a silicone-containing particle for foam or suds control. Such silicone-containing particle is typically formed by mixing or combining a silicone-derived anti-foaming agent with a particulate carrier material.

The silicone-derived anti-foaming agent can be any suitable organosilicones, including, but not limited to: (a) non-functionalized silicones such as polydimethylsiloxane (PDMS); and (b) functionalized silicones such as silicones with one or more functional groups selected from the group consisting of amino, amido, alkoxy, alkyl, phenyl, polyether, acrylate, siliconehydride, mercaptoproyl, carboxylate, sulphate phosphate, quaternized nitrogen, and combinations thereof. In typical embodiments, the organosilicones suitable for use herein have a viscosity ranging from about 10 to about 700,000 CSt (centistokes) at 20° C. In other embodiments, the suitable organosilicones have a viscosity from about 10 to about 100,000 CSt.

Polydimethylsiloxanes (PDMS) can be linear, branched, cyclic, grafted or cross-linked or cyclic structures. In some embodiments, the detergent compositions comprise PDMS having a viscosity of from about 100 to about 700,000 CSt at 20° C.

Exemplary functionalized silicones include but are not limited to aminosilicones, amidosilicones, silicone polyethers, alkylsilicones, phenyl silicones and quaternary silicones. The functionalized silicones suitable for use in the present invention have the following general formula:

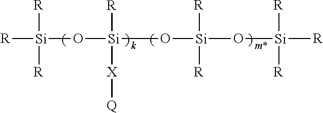

wherein m is from 4 to 50,000, preferably from 10 to 20,000; k is from 1 to 25,000, preferably from 3 to 12,000; each R is H or C1-C8 alkyl or aryl group, preferably C1-C4 alkyl, and more preferably a methyl group.

X is a linking group having the formula:
(i) —(CH2)p-, wherein p is from 2 to 6, preferably 2 to 3;
ii)

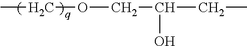

wherein q is from 0 to 4, preferably 1 to 2; or (iii)

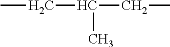

Q has the formula:
(i) —NH2, —NH—(CH2)r-NH2, wherein r is from 1 to 4, preferably 2 to 3; or
(ii) —(O—CHR2—CH2)s-Z, wherein s is from 1 to 100, preferably 3 to 30;
wherein R2 is H or C1-C3 alkyl, preferably H or CH3; and Z is selected from the group consisting of —OR3, —OC(O)R3, —CO—R4-COOH, —SO3, —PO(OH)2, and mixtures thereof; further wherein R3 is H, C1-C26 alkyl or substituted alkyl, C6-C26 aryl or substituted aryl, C7-C26 alkylaryl or substituted alkylaryl groups, preferably R3 is H, methyl, ethyl propyl or benzyl groups; R4 is —CH2- or —CH2CH2- groups; and
(iii)

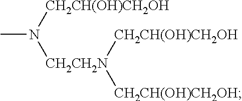

(iv)

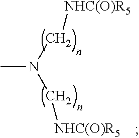

wherein each n is independently from 1 to 4, preferably 2 to 3; and R.sub.5 is C1-C4 alkyl, preferably methyl.

Another class of preferred organosilicone comprises modified polyalkylene oxide polysiloxanes of the general formula:

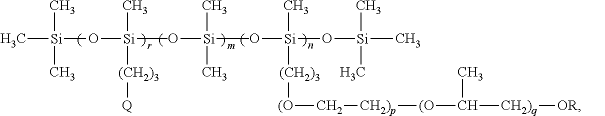

wherein Q is NH2 or —NHCH2CH2NH2; R is H or C1-C6 alkyl; r is from 0 to 1000; m is from 4 to 40,000; n is from 3 to 35,000; and p and q are integers independently selected from 2 to 30.

When r is 0, non-limiting examples of such polysiloxanes with polyalkylene oxide are Silwet® L-7622, Silwet® L-7602, Silwet® L-7604, Silwet® L-7500, Magnasoft® TLC, available from GE Silicones of Wilton, CT; Ultrasil® SW-12 and Ultrasil® DW-18 silicones, available from Noveon Inc., of Cleveland, Ohio; and DC-5097, FF-400® available from Dow Corning of Midland, Mich. Additional examples are KF-352®, KF-6015®, and KF-945®, all available from Shin Etsu Silicones of Tokyo, Japan.

When r is 1 to 1000, non-limiting examples of this class of organosilicones are Ultrasil® A21 and Ultrasil® A-23, both available from Noveon, Inc. of Cleveland, OH; BY16-876® from Dow Corning Toray Ltd., Japan; and X22-3939A® from Shin Etsu Corporation, Tokyo Japan.

A third class of preferred organosilicones comprises modified polyalkylene oxide polysiloxanes of the general formula:

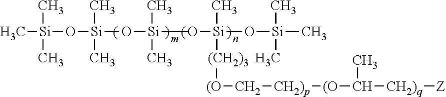

wherein m is from 4 to 40,000; n is from 3 to 35,000; and p and q are integers independently selected from 2 to 30.

Z is selected from:
(i) —C(O)—R7, wherein R7 is C1-C24 alkyl group;
(ii) —C(O)—R4-C(O)—OH, wherein R4 is CH2 or CH2CH2;
(iii) —SO3;
(iv) —P(O)OH2;
(v)

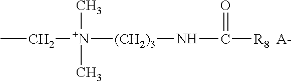

wherein R8 is C1-C22 alkyl and A- is an appropriate anion, preferably Cr;
(vi)

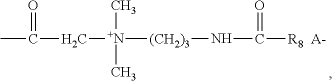

wherein R8 is C1-C22 alkyl and A- is an appropriate anion, preferably Cl⁻.

Another class of preferred silicones comprises cationic silicones. These are typically produced by reacting a diamine with an epoxide. They are described in WO 02/18528 and WO 04/041983 (both assigned to P&G), WO 04/056908 (assigned to Wacker Chemie) and U.S. Pat. No. 5,981,681 and U.S. Pat. No. 5,807,956 (assigned to OSi Specialties). These are commercially available under the trade names Magnasoft® Prime, Magnasoft® HSSD, Silsoft® A-858 (all from GE Silicones) and Wacker SLM21200®.

Organosilicone emulsions, which comprise organosilicones dispersed in a suitable carrier (typically water) in the presence of an emulsifier (typically an anionic surfactant), can also be used as the anti-foaming agent in the present invention. In another embodiment, the organosilicones are in the form of microemulsions. The organosilicone microemulsions may have an average particle size in the range from about 1 nm to about 150 nm, or from about 10 nm to about 100 nm, or from about 20 nm to about 50 nm. Microemulsions are more stable than conventional macroemulsions (average particle size about 1-20 microns) and when incorporated into a product, the resulting product has a preferred clear appearance. More importantly, when the composition is used in a typical aqueous wash environment, the emulsifiers in the composition become diluted such that the microemulsions can no longer be maintained and the organosilicones coalesce to form significantly larger droplets which have an average particle size of greater than about 1 micron.

Suitable particulate carrier materials that can be used in forming the silicone-containing particles described hereinabove include, but are not limited to: silica, zeolite, bentonite, clay, ammonium silicates, phosphates, perborates, polymers (preferably cationic polymers), polysaccharides, polypeptides, waxes, and the like.

In a preferred but not necessary embodiment of the present invention, the silicone-containing particle used herein contains a polydimethylsiloxane or polydiorganosiloxane polymer, hydrophobic silica particles, a polycarboxylate copolymer binder, an organic surfactant, and a zeolite carrier. Suitable silicone-containing particles that are commercially available include those under the tradename Dow Corning® Antifoam from Dow Corning Corporation (Midland, Minn..

### Cationic Polymers

The cleaning composition of the present invention may one or more cationic polymers having a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

Suitable cationic polymers for the practice of the present invention may be synthetic polymers made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N, N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2- propenyl)aminopropyl-9- oxo-8-azo-decane-1,4,10-triammonium trichloride, vinylamine, allylamine, vinyl imidazole, quaternized vinyl imidazole, diallyl dialkyl ammonium chloride, and derivatives or combinations thereof, with one or more nonionic monomers selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS), and derivatives and combinations thereof. The cationic polymer may optionally be branched or cross-linked by using branching and crosslinking monomers.

In another aspect, the cationic polymers may be selected from the group consisting of cationic polysaccharide, polyethyleneimine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethyl ammonium chloride), poly(acrylamide-co-diallyldimethylammonium chloride-co-acrylic acid), poly(acrylamide-co-diallyldimethylammonium chloride-co-vinyl pyrrolidone), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride). Suitable cationic polymers can specifically be selected from the group consisting of Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients. A particularly preferred cationic polymer for the practice of the present invention is Polyquarternium-7.

The cationic polymers may contain charge neutralizing anions such that the overall polymer is neutral under ambient conditions. Non-limiting examples of suitable counter ions (in addition to anionic species generated during use) include chloride, bromide, sulphate, methylsulphate, sulfonate, methylsulfonate, carbonate, bicarbonate, formate, acetate, citrate, nitrate, and mixtures thereof.

The weight-average molecular weight of the cationic polymer may be from about 500 to about 5,000,000, or from about 1,000 to about 2,000,000, or from about 2,500 to about 1,500,000 Daltons, as determined by size exclusion chromatography relative to polyethyleneoxide standards with RI detection. In one aspect, the MW of the cationic polymer may be from about 500 to about 300,000 Daltons.

Such cationic polymer can be provided in the amount of from about 0.01 wt % to about 15 wt %, preferably from about 0.05 wt % to about 10 wt %, and more preferably from about 0.1 wt % to about 5 wt % by total weight of the cleaning composition.

### Adjunct Components

The cleaning composition of the present invention may comprise one or more additional adjunct components. The precise nature of these additional adjunct components, and levels of incorporation thereof, will depend on the physical form of the composition and the nature of the operation for which it is to be used. Suitable adjunct materials include, but are not limited to, builders, carriers, structurants, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, hydrotropes, processing aids, and/or pigments.

In a preferred embodiment of the present invention, the cleaning composition of the present invention is a granular laundry detergent composition comprising one or more builders in the amount ranging from about 1 wt % to about 80 wt %, typically from 2 wt % to 60 wt %, or even from about 5 wt % to about 50 wt %, or from 8 wt % to 40 wt % by total weight of such composition. Builders as used herein refers to any ingredients or components that are capable of enhancing or improving the cleaning efficiency of surfactants, e.g., by removing or reducing “free” calcium/magnesium ions in the wash solution to “soften” or reducing hardness of the washing liquor.

The cleaning composition of the present invention, when it is in a powder or granular form, may also contain a water-soluble alkali metal carbonate. Suitable alkali metal carbonate that can be used for practice of the present invention include, but are not limited to, sodium carbonate, potassium carbonate, sodium bicarbonate, and potassium bicarbonate (which are all referred to as “carbonates” or “carbonate” hereinafter). Sodium carbonate is particularly preferred. Potassium carbonate, sodium bicarbonate, and potassium bicarbonate can also be used. Such water-soluble alkali metal carbonate can be present in the cleaning composition at a level ranging from about 5 wt % to about 50 wt %.

Carbonates have been used in relatively high concentrations (e.g., 25 wt % or more) in cleaning compositions containing a surfactant system formed of LAS and MCAS anionic surfactants as described hereinabove, in order to provide generate sufficient suds during the wash cycle. However, the high carbonate concentration in the cleaning composition inevitably increase the pH of the wash liquor, rendering it harsher and more damaging to the skin surface of handwash consumers. In the present invention, higher levels of soaps thereof are employed to boost or maintain wash suds, which enables reduction of the carbonate level in the cleaning composition without compromising the overall sudsing profile of such composition, thereby providing a milder formulation more suitable for hand-wash consumers.

Correspondingly, the cleaning compostion preferably contains a relatively low level of the water-soluble alkali metal carbonate, such as, for example, from about 6 wt % to about 30 wt %, and preferably from about 8 wt % to about 25 wt %. In a most preferred embodiment of the present invention, the cleaning composition of the present invention includes from about 10 wt % to about 20 wt % of sodium carbonate or sodium bicarbonate.

Preferably but not necessarily, the cleaning composition of the present invention is a granular laundry detergent composition containing: (1) from 5% to 50%, preferably from 6% to 30%, of a water-soluble alkali metal carbonate by total weight of the cleaning composition, wherein the water-soluble alkali metal carbonate is preferably sodium carbonate or sodium bicarbonate; and/or (2) from 20% to 65%, preferably from 30% to 50%, of sodium chloride and/or sodium sulphate by total weight of the cleaning composition; and/or (3) from 0% to 15% of a builder selected from the group consisting of zeolite, phosphate and silicate, by total weight of said cleaning composition, while the cleaning composition is characterized by a moisture content of less than 3% (i.e., 0-3%) by weight.

It is particularly desirable that such granular laundry detergent composition has relatively low levels of phosphate builder, zeolite builder, and silicate builder. Preferably, it contains at most 15 wt % by weight of phosphate builder, zeolite builder, and silicate builder in total. More preferably, such granualar laundry detergent composition contains from 0 wt % to about 5 wt % of phosphate builder, from 0 wt % to about 5 wt % of zeolite builder, and from 0 wt % to about 10 wt % of silicate builder, while the total amounts of these builders add up to no more than 10 wt % by total weight of the composition. Still more preferably, the granualar laundry detergent composition contains from 0 wt % to about 2 wt % of phosphate builder, from 0 wt % to about 2 wt % of zeolite builder, and from 0 wt % to about 2 wt % of silicate builder, while the total amounts of these builders add up to no more than 5 wt % by total weight of the composition.

Most preferably, the granualar laundry detergent composition contains from 0 wt % to about 1 wt % of phosphate builder, from 0 wt % to about 1 wt % of zeolite builder, and from 0 wt % to about 1 wt % of silicate builder, while the total amounts of these builders add up to no more than 2 wt % by total weight of the composition. The composition may further comprise any other supplemental builder(s), chelant(s), or, in general, any material which will remove calcium ions from solution by, for example, sequestration, complexation, precipitation or ion exchange. In particular the composition may comprise materials having at a temperature of 25° C. and at a 0.1M ionic strength a calcium binding capacity of at least 50 mg/g and a calcium binding constant log K Ca²⁺ of at least 3.50.

The granular laundry detergent composition of the present invention may contain one or more solid carriers selected from the group consisting of sodium chloride, potassium chloride, sodium sulphate, and potassium sulphate. In a preferred, but not necessary embodiment, such granular laundry detergent composition includes from about 20 wt % to about 60 wt % of sodium chloride and/or from about 20 wt % to about 60 wt % of sodium sulphate. When the granular laundry detergent composition is in a concentrated form, the total amount of sodim chloride and/or sodium sulphate in such composition may sum up, for example, to a total amount of from about 0 wt % to about 60 wt %.

The cleaning composition of the present invention may further comprise one or more suitable detergent ingredients such as transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### Cleaning Composition

The detergent composition is typically a laundry detergent composition or a dish washing detergent composition. Typically, the composition is a laundry detergent composition.

The laundry detergent composition may be in the form of a liquid, gel, paste, dispersion, typically a colloidal dispersion or any combination thereof. Liquid compositions typically have a viscosity of from 500 mPa·s to 3,000 mPa·s, when measured at a shear rate of 20 s⁻¹ at ambient conditions (20° C. and 1 atmosphere), and typically have a density of from 800 g/l to 1300 g/l. If the composition is in the form of a dispersion, then it will typically have a volume average particle size of from 1 micrometer to 5,000 micrometers, typically from 1 micrometer to 50 micrometers. Typically, a Coulter Multisizer is used to measure the volume average particle size of a dispersion. Preferably, the laundry detergent composition is in a liquid form containing cleaning actives solubilised or dispersed in a solvent. Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

The laundry detergent composition can also be, and is preferably, in a solid or a particulate form, typically in a free-flowing particulate form. The composition in solid form can be in the form of an agglomerate, granule, flake, extrudate, bar, tablet or any combination thereof. The solid composition can be made by methods such as dry-mixing, agglomerating, compaction, spray drying, pan-granulation, spheronization or any combination thereof. The solid composition typically has a bulk density of from 300 g/l to 1,500 g/l, typically from 500 g/l to 1,000 g/l.

The laundry detergent composition may be in unit dose form, including not only tablets, but also unit dose pouches wherein the composition is at least partially enclosed, typically completely enclosed, by a film such as a polyvinyl alcohol film.

The laundry detergent composition may also be in the form of an insoluble substrate, for example a non-woven sheet, impregnated with detergent actives.

The laundry detergent composition may be capable of cleaning and/or softening fabric during a laundering process. Typically, the composition is formulated for use in an automatic washing machine or for hand-washing use, and preferably for hand-wash.

### Methods of Using the Cleaning or Laundry Detergent Composition

The compositions are typically used for cleaning and /or treating a situs inter alia a surface or fabric. As used herein, “surface” may include such surfaces such as dishes, glasses, and other cooking surfaces, hard surfaces, hair or skin. Such method includes the steps of contacting an embodiment of the laundry detergent or cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, “washing” includes but is not limited to, scrubbing, wiping, and mechanical agitation.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

As will be appreciated by one skilled in the art, the laundry detergent of the present invention are ideally suited for use in laundry applications. Accordingly, the present invention includes a method for laundering a fabric. The method may comprise the steps of contacting a fabric to be laundered with a laundry detergent comprising the carboxyl group-containing polymer. The fabric may comprise most any fabric capable of being laundered in normal consumer use conditions. The solution preferably has a pH of from about 8 to about 10.5. The laundry detergent may be employed at concentrations of from about 500 ppm to about 15,000 ppm in solution, and optionally, more dilute wash conditions can be used. The water temperatures typically range from about 5° C. to about 90° C. The water to fabric ratio is typically from about 1:1 to about 30:1.

The method of laundering fabric may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand washing conditions, and can depend on the number of rinses.

Typically from 0.01 Kg to 2 Kg of fabric per litre of wash liquor is dosed into the wash liquor. Typically from 0.01 Kg, or from 0.05 Kg, or from 0.07 Kg, or from 0.10 Kg, or from 0.15 Kg, or from 0.20 Kg, or from 0.25 Kg fabric per litre of wash liquor is dosed into the wash liquor.

Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### EXAMPLES

The following examples are given by way of illustration only and therefore should not be construed to limit the scope of the invention.

### Example 1

### Comparative Tests Showing Sudsing Performance of the Inventive Soap Particles

Eight (8) exemplary granular laundry detergent formulations are prepared to demonstrate the impact of soap particle sizes on the sudsing performance of the laundry detergent formlations. These exemplary formulations include: (1) 1 control formulation A, which contains 0% soaps; (2) Formulation 1, which is the same as the controla formulation A except that it contains 4 wt % of pre-dissolved soap (not in particulate form); (3) Formulation 2, which is the same as the controla formulation A except that it contains 4 wt % of a commercially available soap material that contains only 15 wt % of soap particles having particle sizes of 125-250 microns and 16 wt % of soap particles having particle sizes of 250-355 microns; (4) Formulation 3, which is the same as the controla formulation A except that it contains 4 wt % of soap particles with particle sizes equal to or smaller than 125 microns; (5) Formulation 4, which is the same as the controla formulation A except that it contains 4 wt % of soap particles with particle sizes of 125-250 microns; (6) Formulation 5, which is the same as the controla formulation A except that it contains 4 wt % of soap particles with particle sizes of 250-355 microns; (7) Formulation 6, which is the same as the controla formulation A except that it contains 4 wt % of soap particles with particle sizes of 355-425 microns; and (8) Formulation 7, which is the same as the controla formulation A except that it contains 4 wt % of soap particles with particle sizes greater than 425 microns. The compositional breakdown of these formulatiosn are shown in Table I:

TABLE I

| Ingredients (wt %) | A | 1 | 2 | 3 | 4 | 5 | 6 | 7 |
|---|---|---|---|---|---|---|---|---|
| LAS | 8 | 8 | 8 | 8 | 8 | 8 | 8 | 8 |
| AS | 2 | 2 | 2 | 2 | 2 | 2 | 2 | 2 |
| Carbonate | 20 | 20 | 20 | 20 | 20 | 20 | 20 | 20 |
| Silicate | 4.9 | 4.9 | 4.9 | 4.9 | 4.9 | 4.9 | 4.9 | 4.9 |
| Polyethyleneimine | 0.5 | 0.5 | 0.5 | 0.5 | 0.5 | 0.5 | 0.5 | 0.5 |
| Acrylic acid/maleic acid | 2 | 2 | 2 | 2 | 2 | 2 | 2 | 2 |
| copolymer | | | | | | | | |
| Pre-dissolved soap | 0 | 4 | 0 | 0 | 0 | 0 | 0 | 0 |
| Commercial soap* | 0 | 0 | 4 | 0 | 0 | 0 | 0 | 0 |
| Soap Particles (<125 μm) | 0 | 0 | 0 | 4 | 0 | 0 | 0 | 0 |
| Soap Particles (125-250 μm) | 0 | 0 | 0 | 0 | 4 | 0 | 0 | 0 |
| Soap Particles (250-355 μm) | 0 | 0 | 0 | 0 | 0 | 4 | 0 | 0 |
| Soap Particles (355-425 μm) | 0 | 0 | 0 | 0 | 0 | 0 | 4 | 0 |
| Soap Particles (>425 μm) | 0 | 0 | 0 | 0 | 0 | 0 | 0 | 4 |
| Sodium Sulfate | Q.S. | Q.S. | Q.S. | Q.S. | Q.S. | Q.S. | Q.S. | Q.S. |

*A soap powder sourced from Taiko Palm Oleo Zhangjiagang Co., Ltd., which contains about 5 wt % soap particles with particle sizes smaller than 120 microns, about 15 wt % soap particles with particle sizes of 120-250 microns, about 16 wt % soap particles with particle sizes of 250-355 microns, about 8 wt % soap particles with particle sizes of 355-425 microns, and about 56 wt % soap particles with particle sizes greater than 425 microns.

To demonstrate the improved sudsing profile achieved by the Inventive Soap Particles, the Wash Suds Height of each exemplary formulation is measured using a Suds Cylinder Tester (SCT). To achieve standard testing conditions, reversed-osmosis water (“RO-water”) is used, and standardized water hardness is achieved by adding sodium bicarbonate to the appropriate level to achieve suitably representative water hardness. For the purposes of this testing, the target water hardness is 10 gpg.

Wash Suds Height is measured by comparing suds volume generated during the washing stage by the exemplary granular laundry detergent formulations. The higher the Wash Suds Height, the better the results.

The suds volume of the respective laundry detergent compositions can be measured by employing a suds cylinder tester (SCT). The SCT has a set of 8 cylinders. Each cylinder is a columniform plastic cylinder of about 66 cm in height and 50 mm in diameter, with rubber stopple for airproofing independently rotated at a rate of 21-25 revolutions per minute (rpm). The external wall of each cylinder contains markings for heights, with 0 mm starting from the top surface of the cylinder bottom and ending with 620 mm as the maximum measurable height.

For each suds volume measurement, a test solution is first poured into one of the cylinders soap particle is added with the test level in the SCT, which is then rotated for a number of revolutions as specified below, and then stopped. The suds height of the test solution inside the cylinder is read at about 1 minute after the rotation of the SCT is stopped. The suds height is calculated as the height of the top layer of suds minus the height of the test solution in the cylinder. The height of the top layer of suds is determined by the imaginary line that is at the highest point in the column of suds that passes through suds only without intersecting air and it is vertical to the cylinder wall. Scattered bubbles clinging to the interior surface of the cylinder wall are not counted in reading the suds height.

The Wash Suds Height is an average of 3 measurements taken after four sets of SCT revolutions. The Wash Suds Height is obtained by dissolving 3000 ppm of laundry detergent composition into 300 ml of RO-water adjusted to 10 gpg hardness in the SCT cyclinders. The first set of SCT revolutions is 80 revolutions. After 80 revolutions the SCT is stopped and allow to add 1/64 piece of WFK soils (purchased from Equest). After 40 revolutions, the SCT is stopped and allow to add 1/64 piece of WFK soils and 0.4 g Beijing Clay. After another 80 revolutions the SCT is stopped and allow to add 1/64 piece of WFK soils and 0.4 g Beijing Clay. After another 40 revolutions the SCT is stopped to read and record the data as end of suds height (total 240 revolutions). After another 40 revolutions the SCT is stopped and ready for the wash suds measurement.

The same process as described hereinabove is repeated for each of the eight (8) test samples listed in Table I to obtain the Wash Suds Height, which can be carried out either sequentially or simultaneously.

The Wash Suds Heights measured for each of the above-mentioned seven (7) test samples according to the testing methods described hereinabove are shown hereinafter:

TABLE II

| | A | 1 | 2 | 3 | 4 | 5 | 6 | 7 |
|---|---|---|---|---|---|---|---|---|
| Wash Suds | 22.60 | 21.41 | 21.97 | 22.28 | 23.34 | 23.21 | 21.96 | 21.71 |
| Height (cm) | | | | | | | | |

It is clear from the above results that only Formulations 4 and 5 containign 4 wt % of Inventive Soap Particles of the present invention functions to increase the wash suds volume in comparison with the control Formulation A. The other Formulations 1-3 and 6-7 containing pre-dissolved soap, or soap particles outside of the desired particle size range, or some Inventive

Soap Particles but outside of the desired level (i.e., at least 1.5 wt %) all lead to reduction in the wash suds volume in comparison with the control Formulation A.

### Example 2

### Exemplary Granular Laundry Detergent Compositions

| Ingredients (wt %) | A | B | C | D | E | F | G | H |
|---|---|---|---|---|---|---|---|---|
| LAS (Non-sulphated | 7 | 9 | 9 | 11 | 12 | 14 | 14 | 10.5 |
| anionic surfactant) | | | | | | | | |
| Mid-cut AS or Coconut | 2.2 | 1.5 | 1.5 | 2.2 | 1.0 | 1.0 | 0.7 | 1.5 |
| AS | | | | | | | | |
| Mid-cut AE1S or | 0 | 0.4 | 0 | 0 | 0.4 | 0 | 1 | 0 |
| Coconut AE1S | | | | | | | | |
| Inventive Soap Particles | 4 | 1.5 | 2.5 | 2 | 5.5 | 2.5 | 3 | 3.5 |
| Dimethyl hydroxyethyl | 0 | 1 | 0 | 0 | 0 | 1 | 0 | 0 |
| lauryl ammonium | | | | | | | | |
| chloride | | | | | | | | |
| Non-Ionic (C12-14 EO7) | 1 | 0 | 0 | 1 | 0 | 0.6 | 0 | 0 |
| Zeolite | 0-5 | 0-5 | 0-5 | 0-5 | 0-5 | 0-5 | 0-5 | 0-5 |
| PEI suds collapser | 0.5 | 0 | 2 | 0.5 | 0.5 | 1 | 0.5 | 0.7 |
| Amphiphilic graft | 1.0 | 0 | 1 | 0 | 0.5 | 0.5 | 0 | 0 |
| polymer | | | | | | | | |
| Cationic polymer | 0.5 | 0 | 0.5 | 0 | 0 | 0 | 0.5 | 0 |
| (Polyquartenium 7) | | | | | | | | |
| Protease (54.5 mg/g) | 0-1 | 0-1 | 0-1 | 0-1 | 0-1 | 0-1 | 0-1 | 0-1 |
| Amylase (29.26 mg/g) | 0-1 | 0-1 | 0-1 | 0-1 | 0-1 | 0-1 | 0-1 | 0-1 |
| Xyloglucanase | 0-1 | 0-1 | 0-1 | 0-1 | 0-1 | 0-1 | 0-1 | 0-1 |
| Polymeric dispersing or | 0-2 | 0-3 | 0-2 | 0-2 | 0-3 | 0-2 | 0-3 | 0-2 |
| soil release agent(s) | | | | | | | | |
| Bleach and bleach | 0-5 | 4-6 | 2-3 | 0-5 | 4-6 | 2-3 | 4-6 | 2-3 |
| activator | | | | | | | | |
| Silicate | 0-5 | 0-5 | 3-5 | 0-5 | 0-5 | 3-5 | 0-5 | 3-5 |
| Sodium Carbonate | 15-25 | 12-22 | 15-30 | 8-22 | 15-25 | 6-20 | 15-25 | 10-20 |
| Silicone Particle | 0 | 0.5 | 0 | 0 | | 1 | 0 | 0 |
| Sodium Sulfate | balance | balance | balance | 30-70 | balance | balance | 0 | balance |
| Sodium Chloride | 0 | 20-40 | 0 | balance | 0 | 0 | balance | 0 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
(a) from 5% to 50% of one or more non-soap surfactants by total weight of said cleaning composition;
(b) from 1.5% to 10% of soap particles by total weight of said cleaning composition, wherein said soap particles are characterized by a particle size distribution with from 35 wt % to 100 wt % of soap particles having particle sizes ranging from about 125 microns to about 355 microns.

2. The cleaning composition of claim 1, which is in a granular form, and which is preferably a granular detergent composition.

3. The cleaning composition of claim 1, wherein the soap particles are present in an amount ranging from 2% to 6% and preferably from 2.5% to 5% by total weight of said cleaning composition.

4. The cleaning composition of claim 1, wherein said soap particles are characterized by a particle size distribution with from 40 wt % to 100 wt %, preferably from 45 wt % to 100 wt %, more preferably from 70 wt % to 100 wt %, and most preferably from 90 wt % to 100 wt %, of soap particles having particle sizes ranging from 125 microns to 355 microns.

5. The cleaning composition of claim 1, wherein said soap particles are characterized by a particle size distribution with from 20 wt % to 100 wt %, preferably from 25 wt % to 100 wt %, more preferably from 50 wt % to 100 wt %, and most preferably from 90 wt % to 100 wt %, of soap particles having particle sizes ranging from 125 microns to 250 microns.

6. The cleaning composition of claim 1, wherein said one or more non-soap surfactants comprise one or more anionic surfactants in the amount ranging from 80% to 100% by total weight of said non-soap surfactants, and preferably said one or more anionic surfactants comprise:
(i) a C₁₀-C₂₀ linear alkylbenzene sulphonate (LAS); and
(ii) an alkyl sulphate (AS) having a branched or linear unalkoxylated alkyl group comprising from 6 to 18 carbon atoms,
wherein said LAS and AS are present in said cleaning composition at a LAS-to-AS weight ratio of from 3:1 to 24:1, preferably from 3.5:1 to 20:1, more preferably from 4:1 to 15:1, and most preferably from 5:1 to 10:1.

7. The cleaning composition according to claim 1, wherein said one or more non-soap surfactants further comprise one or more nonionic surfactants in the amount ranging from 0.01% to 2% by total weight of said cleaning composition.

8. The cleaning composition according to claim 7, wherein said one or more nonionic surfactants comprise a C₈₋₁₈ alkyl alkoxylated alcohol having a weight average degree of alkoxylation of from 1 to 50, preferably from 1 to 40, and more preferably from 1 to 30.

9. The cleaning composition according to claim 1, which is substantially free of alkoxylated alkyl sulphate.

10. The cleaning composition according to claim 1, further comprising from 0.3% to 2%, preferably from 0.35% to 1%, of an alkoxylated polyalkyleneimine by total weight of said cleaning composition.

11. The cleaning composition of claim 10, wherein the alkoxylated polyaklyleneimine has an empirical formula of (PEI)ₐ(CH₂CH₂O)_{b}(CH₂CH₂CH₂O)_{c}, wherein PEI is a polyethyleneimine (PEI) core with one or more side chains attached to one or more nitrogen atoms in said PEI core, said PEI core having an average number-average molecular weight a ranging from 100 to 100,000, preferably from 200 to 5000, and more preferably from 500 to 1000; wherein b is the weight average number of ethylene oxide (CH₂CH₂O) units in each of said one or more side chains attached to the PEI core, which is an integer ranging from 10 to 50, preferably from 15 to 40, and more preferably from 20 to 30; and wherein c is the weight average number of propylene oxide (CH₂CH₂CH₂O) units in each of said one or more side chains attached to the PEI core, which is an integer from 1 to 50, preferably from 5 to 40, and more preferably from 10 to 30.

12. The cleaning composition according to claim 1, further comprising from 0.3% to 3%, preferably from 0.35% to 2%, of an amphiphilic graft copolymer by total weight of said cleaning composition, wherein the amphiphilic graft copolymer comprises a polyalkylene oxide backbone grafted with one or more side chains selected from the group consisting of polyvinyl acetate, polyvinyl propionate, polyvinyl butyrate, and combinations thereof, and wherein the weight ratio of the polyalkylene oxide backbone over said one or more said chains ranges from 1:0.2 to 1:10.

13. The cleaning composition of claim 12, wherein the amphiphilic graft copolymer preferably has a polyethylene oxide backbone grafted with polyvinyl acetate side chains.

14. The cleaning composition of claim 1, further comprising one or more protease.

15. The cleaning composition of claim 1, further comprising:
a) from 5% to 50%, preferably from 6% to 30%, of a water-soluble alkali metal carbonate by total weight of said cleaning composition, wherein said water-soluble alkali metal carbonate is preferably sodium carbonate or sodium bicarbonate; and/or
b) from 20% to 65%, preferably from 30% to 50%, of sodium chloride and/or sodium sulphate by total weight of said cleaning composition; and/or
c) from 0% to 15% of a builder selected from the group consisting of zeolite, phosphate and silicate, by total weight of said cleaning composition, wherein said cleaning composition is characterized by a moisture content of less than 3% by total weight of said cleaning composition.

16. Use of the cleaning composition of claim 1 for hand-washing fabrics or other items.

17. Use of soap particles for boosting wash suds and suppressing rinse suds of a cleaning composition, wherein said soap particles are present in the cleaning composition in an amount ranging from 1.5% to 10% by total weight of the cleaning composition, and wherein said soap articles are characterized by a particle size distribution with from 35 wt % to 100 wt % of soap particles having particle sizes ranging from about 125 microns to about 355 microns.
